(19) United States
(12) Patent Application Publication
(10) Pub. No.: US 2008/0312784 A1
(43) Pub. Date: Dec. 18, 2008

(54) System for Controlling a Motor Vehicle Handling

(75) Inventors: Denis Le Bret, Chaville (FR); Patrick Sarri, Chevilly-Larue (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/067,171

(22) PCT Filed: Sep. 11, 2006
(86) PCT No.: PCT/FR06/50864

§ 371 Date: Aug. 5, 2008

(30) Foreign Application Priority Data
Sep. 16, 2005 (FR) 0509503

(51) Int. Cl. G06F 7/00

(52) U.S. Cl. 701/29

(57) ABSTRACT

The invention concerns a motor vehicle (10) comprising a system (52) for controlling the handling thereof and a system (50) for diagnosing the condition of its tyres. Said control system (52) is adapted to control the vehicle handling based on the diagnosed state of the tyres.

The present invention concerns a motor vehicle equipped with a system for controlling its handling and a system for diagnosing the condition of its tires.

Nowadays, motor vehicles are equipped with driving assistance systems that controls their handling, such as, for example, a wheel anti-blocking system, an ABS system, a trajectory control system, an ESP system, a speed limitation/regulation system, an anti-collision system, a trajectory monitoring system, etc.

These vehicles are also equipped with systems for diagnosing the condition of their tires associated with alarms on board the passenger compartment to warn the driver about the state of the tires.

Currently, the vehicle handling control laws executed by the handling assistance system are based on a single state of the tires of the vehicle, i.e., a satisfactory state of these tires.

However, it is known that the dynamic handling of a vehicle is highly influenced by the actual state of the tires, such as, for example, their inflated state, the presence of hernias, unbalances, etc. Indeed, these control laws can be inappropriate if the state of the tires is unsatisfactory.

The goal of the invention is to remedy the above-mentioned problem.

To this effect, an object of the invention is a motor vehicle equipped with a system for controlling its handling and a system for diagnosing the state of its tires, characterized in that said control system is adapted to control the handling of the vehicle as a function of the diagnosed state of the tires.

According to other embodiments, the motor vehicle according to the invention can include one or more of the following characteristics:

the diagnostic system is adapted to diagnose the inflated state of the tires, and in that the control system is adapted to control the handling of the vehicle in a predetermined security mode when the diagnosed inflated state is not satisfactory;

the control system is adapted to limit the speed of the vehicle when the diagnosed inflated state is not satisfactory;

the control system is adapted to reduce the braking power applied to a wheel when the tire of this wheel is diagnosed as being under-inflated; and

the control system is adapted to increase the braking power applied to the wheels of the vehicle whose tires are diagnosed as having satisfactory inflated states to compensate the reduction of the braking power applied to the wheel equipped with a tire diagnosed as being under-inflated.

The invention will be better understood by reading the following description, given by way of example only, with reference to the annexed drawings in which:

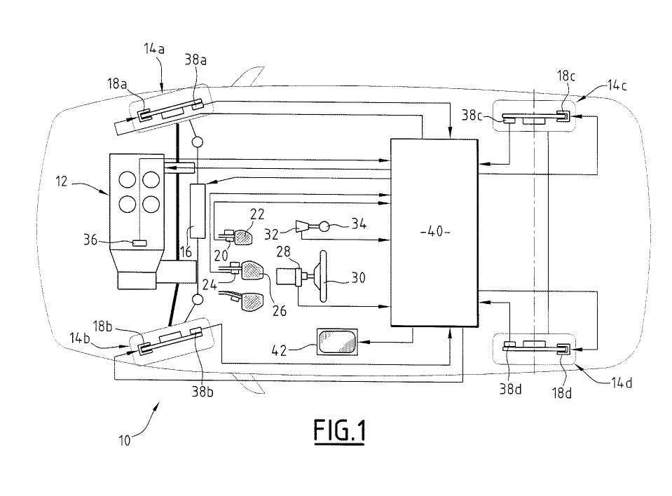

FIG. 1 is a schematic view of a motor vehicle according to the invention; and

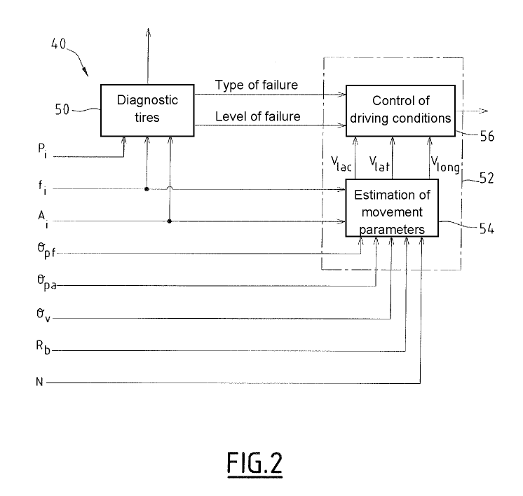

FIG. 2 is a schematic view of a control unit that is part of the construction of the vehicle of FIG. 1.

On FIG. 1, a motor vehicle 10 according to the invention is illustrated schematically.

The vehicle 10 is equipped with an engine 12 for driving, for example, two front wheels 14a, 14b, which are driving wheels, a steering system 16 for turning the front wheels 14a, 14b, which are also turning wheels, and a braking system comprising a brake pad caliper 18a, 18b, 18c, 18d on each of the wheels 14a, 14b, 14c, 14d of the vehicle.

Means for acquiring setpoints supplied by the driver for the engine 12 and the steering 16 and braking 18a, 18b, 18c, 18d systems are provided, which comprise in particular:

a sensor 20 of the position of the acceleration pedal 22 of the vehicle for acquiring the request for driving torque;

a sensor 24 of the position of the brake pedal 26 of the vehicle for acquiring the request for braking torque;

a sensor 28 of the angle of the steering wheel 30 of the vehicle for acquiring the request for steering angle of the turning wheels 14a, 14b; and

a sensor 32 of the position of the shift stick 34 of the vehicle in the case of a manual gear box, or a sensor of the state selection of the gear box in the case of an automatic gear box, for acquiring the engaged transmission reduction ratio of the vehicle's gear box.

Means for acquiring the operating parameters of the vehicle are also provided, which comprise in particular:

an engine speed sensor 36 for acquiring the rotation speed of the engine 12; and

means 38a, 38b, 38c, 38d for acquiring operating parameters of each of the wheels 14a, 14b, 14c, 14d of the vehicle having an angular speed sensor for acquiring its angular speed and, either a mono-axis or tri-axis accelerometer for acquiring its vertical acceleration to estimate the inflating pressure of its tire, or a pressure sensor to measure the inflating pressure of its tire.

The engine 12 and the steering 16 and braking 18a, 18b, 18c, 18d systems are controlled electrically and they receive control signals for the handling of the vehicle 10 from a monitoring unit 40.

This unit 40 is connected to the various acquisition means 20, 24, 28, 32, 36, 38a, 38b, 38c, 38d and it determines these signals as a function of setpoints supplied by the driver and the acquired operating parameters of the vehicle.

Further, the unit 40 determines the state of the tires of the wheels 14a, 14b, 14c, 14d as a function of the measurements it receives.

It is implemented, for example, by a unit for controlling the operation of the vehicle, which is also in charge of other functionalities of the vehicle, such as the determination of the setpoints for fuel injection into the cylinders of the engine or of the air flow rate admitted in these cylinders, for example.

The unit 40 can also be implemented by a dedicated data processing unit.

The vehicle 10 is also equipped with means 42 for supplying visual and/or acoustic data regarding the handling of the vehicle and the state of its tires, such as a display screen or a loudspeaker, for example.

FIG. 2 is a schematic view of the monitoring unit 40.

The unit 40 comprises a module 40 for diagnosing the state of each of the tires of the vehicle, and in particular its inflating state and the presence of hernia and BALOURD. The module 50 estimates this state, in a manner known in itself, as a function of the acquired inflating pressure Pᵢ thereof, the acquired vertical acceleration fᵢ of the wheel, and the acquired rotation speed Aᵢ of the wheel on which it is mounted. The module 50 estimates in particular the type and the failure level of the tire and supplies them to the data supply means 42 to warn the vehicle driver thereof.

In particular, the module 50 diagnoses that the tire is under-inflated if its inflating pressure is lower than a first predetermined threshold value and it determines that this under-inflated state is critical if the inflating pressure is lower than a second predetermined threshold value.

The diagnostic module 40 is also connected to a module 52 for controlling the handling of the vehicle.

The module 52 has means 54 for estimating movement parameters of the vehicle, for example, the yaw, lateral, and longitudinal speeds Vlac, Vlat, Vlong of the vehicle as a function of the various acquired data θ_{pf}, θₚₐ, θᵥ, R_{b} and N as it is known in itself.

The module 52 also comprises means 56 connected to the diagnostic module 50 and to the estimation module 52. The means 56 implement a control law of the engine 12 and of the steering 16 and braking 18a, 18b, 18c, 18d systems, such as, for example, an ABS, ESP, and vehicle speed limitation/regulation controls, as a function of the acquired data and of the diagnosed state of the tires.

More particularly, the means 52 select a control law as a function of the state of the tires diagnosed by the unit 40.

For example, if the inflating state of the tires is diagnosed as satisfactory, the means 52 then implement a standard ABS control law. If a tire is diagnosed as being under-inflated, the means 52 select an ABS control law whose effect is to reduce the braking amount applied to the wheel associated with this tire, and whose effect is to increase the braking amount applied to the other wheels whose tires are diagnosed as satisfactory, in order to compensate this braking reduction. The vehicle is thus controlled by the means 52 in a security mode.

The description has been made for a motor vehicle.

Of course, the present invention applies to other types of vehicles, in particular, multi-train, motorcycles, etc.

1. Vehicle equipped with a system for controlling its handling and a system for diagnosing the state of its tires, wherein said control system is adapted to control the handling of the vehicle as a function of the diagnosed state of the tires.

2. Vehicle according to claim 1, wherein the diagnostic system is adapted to diagnose the inflated state of the tires, and the control system is adapted to control the handling of the vehicle in a predetermined security mode when the diagnosed inflated state is not satisfactory.

3. Vehicle according to claim 2, wherein the control system is adapted to limit the speed of the vehicle when the diagnosed inflated state is not satisfactory.

4. Vehicle according to claim 2, wherein the control system is adapted to reduce the braking power applied to a wheel when the tire of this wheel is diagnosed as being under-inflated.

5. Vehicle according to claim 4, wherein the control system is adapted to increase the braking power applied to the wheels of the vehicle whose tires are diagnosed as having satisfactory inflated states to compensate the reduction of the braking power applied to the wheel equipped with a tire diagnosed as being under-inflated.

6. Vehicle according to claim 3, wherein the control system is adapted to reduce the braking power applied to a wheel when the tire of this wheel is diagnosed as being under-inflated.

7. Vehicle according to claim 6, wherein the control system is adapted to increase the braking power applied to the wheels of the vehicle whose tires are diagnosed as having satisfactory inflated states to compensate the reduction of the braking power applied to the wheel equipped with a tire diagnosed as being under-inflated.
